(19) United States
(12) Patent Application Publication
(10) Pub. No.: US 2011/0132890 A1
(43) Pub. Date: Jun. 9, 2011

(54) Stewpot

(76) Inventors: Shangshu DAI, Foshan (CN); Minqiang Feng, Foshan (CN); Tianbing Gao, Foshan (CN)

(21) Appl. No.: 12/650,520

(22) Filed: Dec. 30, 2009

(30) Foreign Application Priority Data
Dec. 4, 2009 (CN) 200920264214.4

(51) Int. Cl. A47J 27/00

(52) U.S. Cl. 219/386

(57) ABSTRACT

A low cost and low surface temperature stewpot for slow cooking includes a lid, an inner layer, an outer layer, a heater, a housing unit and a bottom plate. The outer layer is placed inside of the housing unit, and the inner layer is placed inside of the outer layer; the lid is on top of the inner layer. The heater is installed at the exterior side of the outer layer, and the bottom plate is at the bottom of the housing unit. The outer layer has a shallow tray structure; the housing unit bottom is of annular shape with an open at the center and an “R angle” circular transition at the connection of the bottom and the side of the housing unit; the outer layer is fastened to the bottom of the housing unit.

### FIELD OF INVENTION

The present invention relates to a stewpot for slow cooking; the present invention is an improvement of a slow cooking stewpot.

### BACKGROUND

The structure of a currently available stewpot for slow cooking is shown in FIG. 1, which includes a lid 1, an inner layer 2, an outer layer 3 with a heater 4 at its exterior, an housing unit 5 and a bottom plate 7; the housing unit 5 is made of stainless steel with press seam at its side connections, its upper and lower edges are sharp; the outer layer 3 is made of deep drawing aluminum plate, the outer layer 3 has curling upper edge, which is tightly fixed onto the upper edge of the housing unit 5; the lower edge of the housing unit 5 is fixed onto the bottom plate 7, a screw 8 through the outer layer 3 and bottom plate 7 is utilized to fasten the outer layer 3, the housing unit 5, and the bottom plate 7 all together with a nut 9.

The disadvantage of the currently available stewpot for slow cooking are as follows: 1. During the assembly process, the sharp edges of the housing unit can easily scratch other internal members of the stewpot, such as the heater fixed at the exterior of the outer layer and the control plate (not shown) fixed inside of the housing unit etc.; further, the strength of the deep-drawing-aluminum made housing unit is not strong enough, plus the inner layer is heavy, the housing unit can be easily out of shape and seriously affecting the appearances and the usage life expectancy of the stewpot; 2. Because of the housing unit and the upper edge of the outer layer are fixed together, the side edges are close, the heat of the outer layer can be easily transferred to the housing unit, therefore, the temperature of the housing unit can easily reach 100° C., users can be scorched; besides, the deep drawing outer layer has high scrapping rate during assembly; because the bottom plate is independently processed and made, the cost of the pot is high.

### SUMMARY

Accordingly, it is an objective of the present invention is to overcome the disadvantages of the currently available stewpots. It is also an objective to design a stewpot for slow cooking with a lower surface temperature of the housing unit, and lower manufacturing cost.

To implement the above mentioned objectives, the present invention includes the following technical characters: a stewpot for slow cooking includes a lid, an inner layer, an outer layer, a heater, an housing unit and a bottom plate; the outer layer is inside the housing unit, the inner layer is inside the outer layer, the lid is on top of the inner layer, the heater is at the exterior side surface of the outer layer, the bottom plate is at the bottom of the housing unit; the structure of the outer layer is similar to a shallow tray, the height of the sides of the outer layer is lower than the height of the sides of the inner layer.

The shallow tray structure of the present invention significantly lowers the corresponding surface area between the housing unit and the outer layer, and there is no external connection between the housing unit and the outer layer. As a result, the surface temperature of the housing unit is substantially decreased. Because of the height of the outer layer is lower, thus, the required materials are reduced; the manufacturing cost of the stewpot is then low.

To ensure the above mentioned technical effects, and meanwhile guarantee a heating range of the heater, the height of the side of the outer layer is 1/5 to 1/2 of the height of the side of the inner layer; furthermore, one alternative is that the height of the side of the outer layer is 1/4 to 1/3 of the height of the side of the inner layer.

The upper edge of the side of the outer layer is curling outward; the outward curling edge of the outer layer is closely matched with space of the interior of the housing unit. The outward curling upper edge of the side of the outer layer is protecting the various circuitry controllers at the lower part of the outer layer, and is protecting stewpot from water and dust.

There are a plurality of either continuous or discrete annular ribs formed underneath the heater at the side of the outer layer. Alternative design is that there are some plurality of annularly arranged convex spots formed underneath the heater at the external side of the outer layer. The above mentioned either continuous or discrete annular ribs or convex spots not only can enhance the strength of the outer layer but also stabilize the heater.

The side and bottom of the housing unit are uniformly-formed structured, the connection between the side and the bottom of the housing unit is a round curling transition. The structure significantly increases the strength of the housing unit, which does not easily get deformed, solid and durable, most of all, it does not have the problem of scratching other internal members during the assembly process.

The structure of the upper edge of the housing unit is either curling or flanging. This either curling or flanging structure of the upper edge of the housing unit increases the assembly and usage safety, protecting human hands from scratches.

The upper edge of the inner layer is on top of the upper edge of the housing unit, there is a 2-4 mm space between the bottom of the inner layer and the bottom of the outer layer. Therefore, when the upper edge of the inner layer is placed on top of the upper edge of the housing unit, the slim space between the bottom of the inner layer and the bottom of the outer layer guarantees the complete contact between the upper edge of the inner layer and the upper edge of the housing unit; there is no large space between these two members, which significantly decreases the heat radiation from the internal product of the slow cooking stewpot, thereby, increases the heating effect on the product.

The bottom plate is matched with the open at the bottom of the housing unit.

There are some positive effects comparing the present invention with what is available in the market: First, the outer layer is structured as shallow tray, which reduces the cost and decreases the corresponding area between the outer layer and the housing unit; the shallow tray structure significantly decreases the housing unit surface temperature as well. Second, there is a round curling transition at the connection of the bottom and side of the housing unit, which greatly increases structural strength of the housing unit, preventing it from deforming, making it strong and durable. In addition, there is an open at the bottom of the housing unit, the corresponding bottom area, as a result, requires less materials, and hence reduces the cost. The curling or flanging structure of the upper edge of the housing unit alleviates the problem of scratching internal members, at the same time, increases the structural strength of the housing unit.

### BRIEF DESCRIPTION OF DRAWINGS

FIG. 1 is the exploded structure of the current market available stewpot for slow cooking;

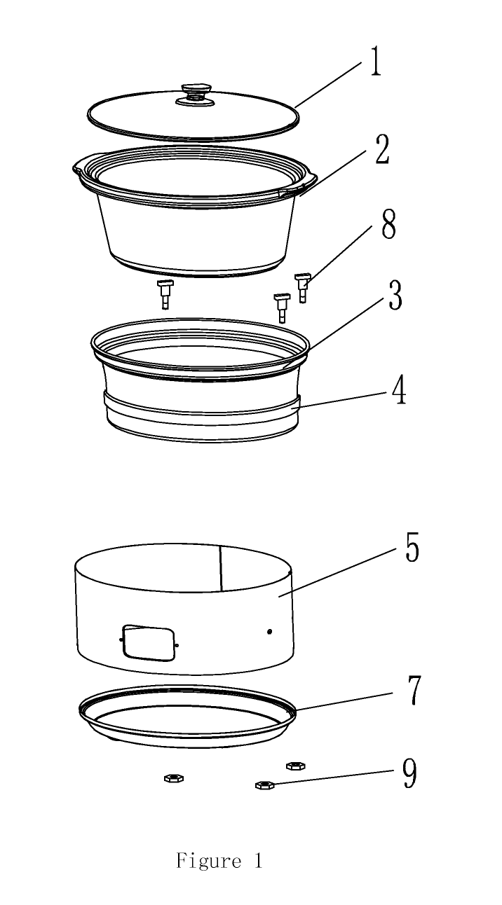

FIG. 2 is a sectional diagram of a preferred embodiment of the stewpot for slow cooking of the present invention; and

FIG. 3 is a structural schematic diagram of a preferred embodiment of the stewpot for slow cooking of the present invention.

### DETAILED DESCRIPTION OF PREFERRED EMBODIMENTS

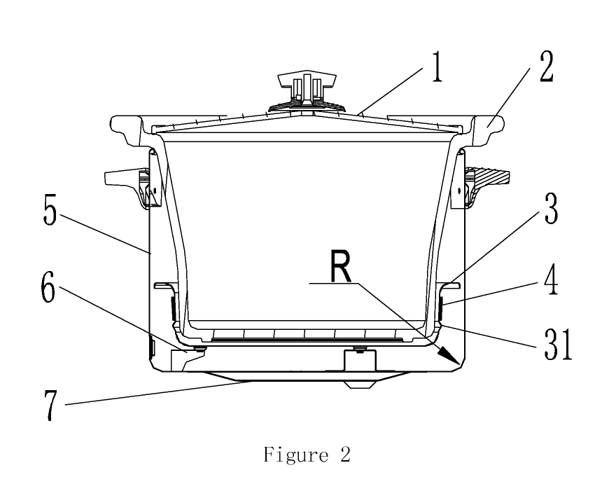

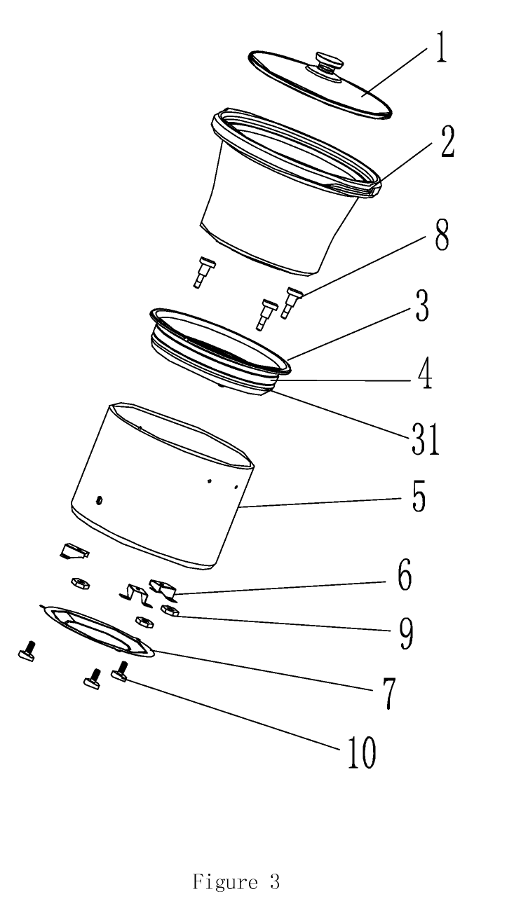

As shown in FIGS. 2 and 3, a preferred embodiment of a stewpot for slow cooking includes a lid 1, an inner layer 2, an outer layer 3, a heater 4, a housing unit 5 and a bottom plate 7, the outer layer 3 is placed inside of the housing unit 5, the inner layer 2 is placed inside of the outer layer 3, the lid 1 is on top of the inner layer 2.

The outer layer 3 is made of metal materials, such as aluminum, iron, or stainless steel and so on, with heat transfer capability, and the structure is shallow tray style. The height of the outer layer 3 is 1/5-1/2 of the height of the inner layer 2, however, the best ratio is 1/4-1/3. The so-called shallow tray is a structure in comparison to the current technology, which makes use of a higher side of the outer layer, because the side of the outer layer needs to be tightly fixed onto the upper edge of the housing unit by way of its curling edge. In the present invention, the outer layer 3 does not have direct connection with the upper edge of the housing unit 5, but is fixedly fastened to the housing unit at the bottom; therefore, the height of the side of the outer layer 3 can be lower than the height of the side of the inner layer 2, and in shallow tray shape. Because that there is no direct connection between the outer layer 3 and the housing unit 5, the heat transfer through contact can be avoided, and the contact area of the housing unit and the outer layer can be significantly reduced, thus reduced the heat radiation area, all these greatly reduce the surface temperature on the housing unit 5; after many experiments, under the same conditions, the stewpot for slow cooking of the present invention has a surface temperature about 25° C. below the contemporary stewpot technology.

Aforementioned outwardly curling upper edge of the outer layer 3; the outwardly curling upper edge of the outer layer 3 is matched with space between the outer layer and the interior surface of the housing unit 5. The outward extrusion length of the curling upper edge can be adjusted according to actual needs; in order to decrease the heat radiation from the outer layer to the housing unit, the length of the outward curling can be extended; in order to reduce the cost, the length of the outward curling can be shortened; the outward curling is mainly protecting the electrical circuitry at the bottom of the outer layer and preventing water and dust to fall into the stewpot; the outward curling is also good for fastening the heating circuitry of the heater 4.

A heater 4 is installed at the exterior side of the outer layer 3, there is a round of continuous or discrete annular convex ribs 31 under the heater 4; another design is that, under the heater of the exterior side of the outer layer, a plurality of convex spots formed and annularly arranged along the exterior side of the outer layer. The convex ribs 31, or the annularly arranged convex spots, not only can enforce the strength of the outer layer but also can enforce the stability of the heating wires of the heater 4.

The housing unit 5 is made of stretched metals, such as cold-rolled plate or stainless steel, the upper edge with curling or flanging structure; its bottom is of annular shape with an open at the center; there is a “R angle” circular transition at the connection of the bottom and the side of the housing unit, the outer layer 3 is fastened to the bottom part of the housing unit 5 by way of a screw 8, a nut 9 and a support 6; there are three supports 6 utilized in the preferred embodiment of the present invention, they are arranged evenly at the bottom of the housing unit 5. The bottom plate 7 is fixedly formed underneath the bottom of the housing unit 5 with bolts 10. In the preferred embodiment, the shape of the bottom plate 7 is matched with the open located at the bottom of the housing unit.

Considering the possible size differences of inner layers made from a same production due to the manufacturing process variations; when the upper edge of the inner layer 2 is placed on top of the upper edge of the housing unit 5, there is a 2-4 mm space reserved between the bottom of the inner layer and the bottom of the outer layer, therefore, the inner layer is placed and connected to the outer layer; when the inner layer is full of food, the weight increases, the inner layer tends to bend a little bit so that it can touch the outer layer and let the outer layer sharing some of the excess weight. This design enables the full contact between the upper edge of the inner layer and the upper edge of the housing unit, no bigger space between these two; it significantly decreases the internal heat radiation of the stewpot for slow cooking, and improves the heating effect of the product.

The lid, inner layer, outer layer and housing unit and so on of the preferred embodiment are round shaped, of course, the design can also be square or oval if so desired.

The stewpot for slow cooking of the present invention includes a housing unit 5 with an upper edge of a curling or flanging structure, and a lower edge is the “R angle” transition bottom, the structural strength is significantly increased, not easy to get deformed, strong and durable, especially without the problem of scratching other members during the assembly process.

The stewpot for slow cooking of the present invention adopted a structure of shallow tray for the outer layer 3, and the bottom plate 7 adopted the same material made up the open at the bottom of the housing unit 7; less material required and low cost.

1. A slow cooker for slow cooking comprises:
a lid;
an inner layer;
an outer layer;
a heater;
a housing unit; and
a bottom plate,
wherein the outer layer is inside of the housing unit, the inner layer is inside of the outer layer, the lid is o top of the inner layer, the heater is at the side surface of the outer layer, the bottom plate is at the bottom of the housing unit, the outer layer having a shallow tray structure, the height of the side of the outer layer is higher than the height of the side of the inner layer.

2. The slow cooker for slow cooking as claimed in claim 1, wherein the height of the side of the outer layer is 1/5˜1/2 of the height of the side of the inner layer.

3. The slow cooker for slow cooking as claimed in claim 2, wherein the upper edge of the side of the outer layer is curling outwardly, and the outward curling upper edge of the outer layer is matched with the slim space of the internal surface of the housing unit.

4. The slow cooker for slow cooking as claimed in claim 2, wherein the height of the side of the outer layer is 1/4˜1/3 of the height of the side of the inner layer.

5. The slow cooker for slow cooking as claimed in claim 4, wherein the upper edge of the side of the outer layer is curling outwardly, and the outward curling upper edge of the outer layer is matched with the slim space of the internal surface of the housing unit.

6. The slow cooker for slow cooking as claimed in claim 1, wherein the upper edge of the side of the outer layer is curling outwardly, and the outward curling upper edge of the outer layer is matched with the slim space of the internal surface of the housing unit.

7. The slow cooker for slow cooking as claimed in claim 1 further comprises a plurality of continuous or discrete annular convex ribs underneath the heater at the side surface of the outer layer.

8. The slow cooker for slow cooking as claimed in claim 1 further comprises a plurality of continuous or discrete annularly arranged convex spots underneath the heater at the side surface of the outer layer.

9. The slow cooker for slow cooking as claimed in claim 1, wherein the sides and bottom of the housing unit are uniformly formed structure, the connection between the side and bottom surfaces have circular transition.

10. The slow cooker for slow cooking as claimed in claim 9, wherein the bottom plate is matched with the shape of the open at the bottom of the housing unit.

11. The slow cooker for slow cooking as claimed in claim 9, wherein the upper edge of the housing unit as curling or flanging structure.

12. The slow cooker for slow cooking as claimed in claim 11, wherein the bottom plate is matched with the shape of the open at the bottom of the housing unit.

13. The slow cooker for slow cooking as claimed in claim 1, wherein the upper edge of the inner layer is placed on the upper edge of the housing unit, the space between the bottom of the inner layer and the bottom of the outer layer is 2˜4 mm.

14. The slow cooker for slow cooking as claimed in claim 13, wherein the bottom plate is matched with the shape of the open at the bottom of the housing unit.
